(19) United States
(12) Patent Application Publication
(10) Pub. No.: US 2003/0079140 A1
(43) Pub. Date: Apr. 24, 2003

(54) Multiple protecting system to protect personal computer data from burglary utilized flash memory drive

(76) Inventor: Yosuke Ura, Urayasu-City (JP)

Correspondence Address: Yosuke URA, Room 103, Irifune 2-26, Urayasu-City, 279-0012, JP

(21) Appl. No.: 10/002,501

(22) Filed: Oct. 24, 2001

(51) Int. Cl. H04L 9/00

(52) U.S. Cl. 713/194

(57) ABSTRACT

This invention provides the system to protect the data stored in personal computer from burglary.

This invention features providing method to protect the data stored in personal computer from easy burglary by combining several types of protecting method in the system that data is input and output inserting flash memory drive into USB port on personal computer.

### BACKGROUND OF THE INVENTION

This invention is the invention related to multiple protecting system to protect personal computer that flash memory drive is utilized from burglary.

Conventionally data of personal computer is mainly stored such memory media that is provided moving mechanism as hard disk and floppy disk; for example FDD, CDRW, and MO. It is impossible to steal the data stored at personal computer during the time other than attracting public attention. However it become possible to steal the data at any time and chance to steal the data is increased because inserting plug into USB port on personal computer can steal the data when flash memory drive is introduced into personal computer.

The flash memory drive system has following demerit. Possibility is high to be stolen data of personal computer easily and surely because the flash memory drive system is light in weight, having no moving part, almost no failure, and short data recording time.

This invention is intended to solve the demerit mentioned above and to protect data stored at flash memory drive provided on personal computer from burglary by providing multiple protecting system.

### SUMMARY OF THE INVENTION

To protect data stored on personal computer from easy burglary by combining several types of protecting method in the method to input and to output the data stored in flash memory drive at USB port on personal computer. Multiple protecting system to protect data stored in personal computer from steal in the system mentioned above.

### DETAILED DESCRIPTION OF THE INVENTION

Followings are description of implementation mode.

1. Uses personal computer 1 with USB port 2 that has capability to use flash memory drive.

2. Inputs ID number of flash memory drive provided at personal computer 1. This make the flash memory drive cannot be used when the flash memory drive has another ID number or no ID number.

3. Uses flash memory drive having adapter 3 special shape that is pairing up with shape of adapter at USB inserting port 2 on personal computer as shown in FIG. 1.

4. Mounts special switch 6 on adapter 3 described in paragraph 3 as shown in FIG. 2.

5. Mounts fixing units 8 on adapter 3 described in paragraph 3. as shown in FIG. 5.

6. Provides mechanism to make memory circuit short circuit when flash memory drive having different shape adapter described in paragraph 3 is inserted into inserting port 5 as shown in FIG. 3.

7. Manufactures flash memory drive adapter and adapter at USB inserting port 2 in pair and makes another flash memory drive incapable to connect. Adapter 3 shall be such structure that it cannot be removed once it is inserted into USB port on personal computer 1 as shown in FIG. 4.

Personal computers that are used most of company use such memory media that is provided moving mechanism as hard disk and floppy disk; for example FDD, CDRW, and MO. However they are weak at mechanical impact and electric shock, which causes breakage and failure and often results in incapable of data. Therefore flash memory drive is widely prevailing to cover demerit of hard disk and floppy disk. Flash memory drive can record large amount of data in a short time by inserting it into USB port on personal computer. Additionally it has resistance to shock. However flash memory drive is very risky for the person to manage data of personal computer because outsider of the company can copy the data stored in personal computer.

Outsider can steal large amount of data stored in personal computer in a short time using flash memory drive while operator leaves the computer. This invention system can prevent data from burglary mentioned above.

### BRIEF DESCRIPTION OF THE DRAWINGS

In the drawings:

FIG. 1 is an explanatory view showing a port of the adapter which has a special shape.

FIG. 2 is an explanatory view showing the adapter which has a special switch on its body.

FIG. 3 is an explanatory view showing the adapter which has mechanism to make memory circuit short circuit.

FIG. 4 is an explanatory view showing a port of the adapter which is produced together with a connecting plug of flash memory drive as one pair.

FIG. 5 is an explanatory view showing the adapter which has fixing units on the connecting plug of it.

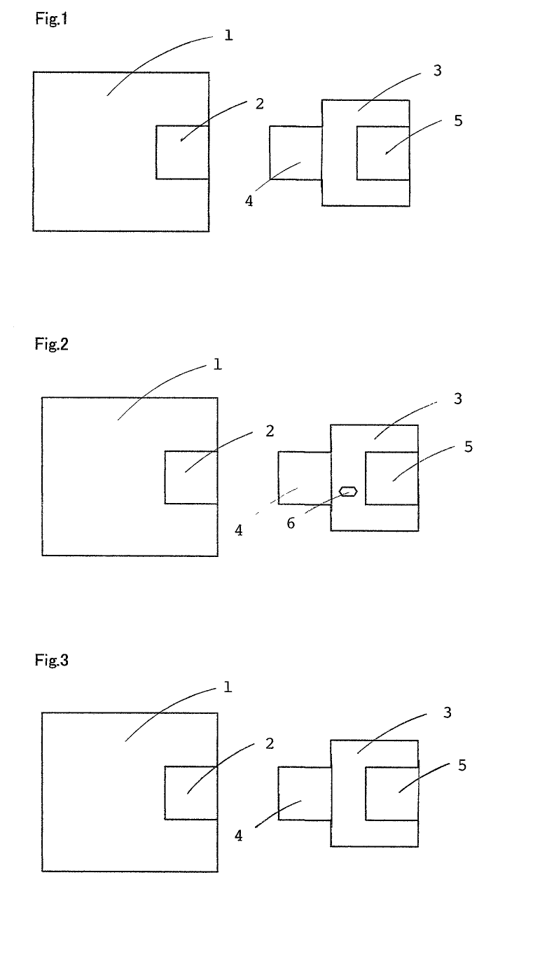

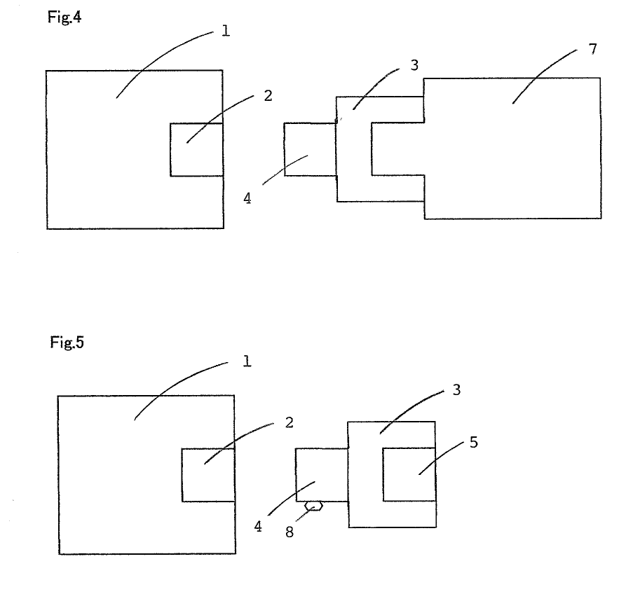

Description of Numerals:

| | |
|---|---|
| 1 | Personal Computer |
| 2 | USB port |
| 3 | Adapter |
| 4 | Connecting Plug |
| 5 | Port on Adapter |
| 6 | Special Switch |
| 7 | Flash Memory Drive |
| 8 | Fixing Unit |

What is claimed is:

1. Multiple protecting system to protect personal computer data in the method that data is inputted or outputted in flash memory drive at USB port of personal computer and is featured to protect personal computer data from ease burglary by combining several kinds of protecting method.

2. Multiple protecting system to protect personal computer data described in claim 1 featured not to allow to mount general shape flash memory drive by mounting special shape adapter at USB port on personal computer.

3. Multiple protecting system to protect personal computer data described in claim 1 featured to mount adapter with special switch at USB port on personal computer.

4. Multiple protecting system to protect personal computer data described in claim 1 featured to mount adapter that is incorporated circuit to make flash memory drive circuit short circuit at USB port on personal computer.

5. Multiple protecting system to protect personal computer data described in claim 1 featured not to allow to dismount adapter easily once mounted by manufacturing shape of adapter that is mounting at USB port on personal computer pairing up with shape of flash memory drive plug that is inserted into USB port plug.

6. Multiple protecting system to protect personal computer data described in claim 1 featured not to allow to use flash memory drive for another personal computer by giving flash memory drive ID number, inputting the ID number into utilizing personal computer, and limiting flash memory drive utilized.
